(19) United States
(12) Patent Application Publication
(10) Pub. No.: US 2014/0132480 A1
(43) Pub. Date: May 15, 2014

(54) MINIATURE ANTENNA

(71) Applicant: Wistron Corporation, New Taipei City (TW)

(72) Inventor: Chen-Yu CHOU, New Taipei City (TW)

(73) Assignee: Wistron Corporation, New Taipei City (TW)

(21) Appl. No.: 14/030,368

(22) Filed: Sep. 18, 2013

(30) Foreign Application Priority Data
Nov. 14, 2012 (TW) 101222022

(51) Int. Cl. H01Q 1/36; H01Q 1/50

(52) U.S. Cl. CPC H01Q 1/36; H01Q 1/50
USPC 343/906; 343/700 MS

(57) ABSTRACT

A miniature antenna includes a feed-in element, a grounding element, a short circuit element and a radiating element. The grounding element includes a feed-in end portion and a link portion connected with the feed-in end portion. The feed-in end portion includes a feed-in point provided for feed-in of a radio frequency signal. The grounding element is spaced apart from the feed-in element and is disposed adjacent to the feed-in point. The short circuit element extends from the link portion to the grounding element, and substantially surrounds the feed-in end portion. The radiating element extends from the link portion, and substantially surrounds the short circuit element.

### CROSS REFERENCE TO RELATED APPLICATION

This application claims priority of Taiwanese application no. 101222022 filed on Nov. 14, 2012, the disclosure of which is incorporated herein by reference.

### BACKGROUND OF THE INVENTION

1. Field of the Invention

The invention relates to a miniature antenna, more particularly to miniaturized inverted F antenna.

2. Description of the Related Art

Owing to the rapid development of communication technology, antennas used for receiving and transmitting radio signals have played a very important role in electronic products. However, due to size reduction trend of electronic products, space allotted for the associated antennas has become smaller and smaller, and therefore it has proven to be more difficult for the structures of the conventional antennas to meet product specifications. In view of this, how to develop a new antenna to meet the requirement of size miniaturization while in the meantime maintaining good efficiency has been presented as a very critical issue.

### SUMMARY OF THE INVENTION

Therefore, an object of the present invention is to provide a miniature antenna having good efficiency.

Accordingly, the miniature antenna of the present invention comprises a feed-in element, a grounding element, a short circuit element and a radiating element. The feed-in element includes a feed-in end portion and a link portion connected electrically with the feed-in end portion. The feed-in end portion includes a feed-in point provided for feed-in of a radio frequency signal. The grounding element is spaced apart from the feed-in element and is disposed adjacent to the feed-in point. The short circuit element extends from the link portion to the grounding element, and substantially surrounds the feed-in end portion. The radiating element extends from the link portion, and substantially surrounds the short circuit element.

An effect of the present invention resides in that, by means of the short circuit element extending from the link portion to the grounding element and substantially surrounding the feed-in end portion, and by means of the radiating element extending from the link portion and substantially surrounding the short circuit element, the miniature antenna may achieve a result of size miniaturization while maintaining good efficiency.

### BRIEF DESCRIPTION OF THE DRAWINGS

Other features and advantages of the present invention will become apparent in the following detailed description of the two embodiments with reference to the accompanying drawings, of which:

FIG. 1 is a schematic structure diagram of a first embodiment of a miniature antenna according to the present invention;

FIG. 2 is an exploded perspective view of the first embodiment;

FIG. 3 is an assembled perspective view of the first embodiment;

FIG. 4 is a plot of gain versus frequency of the first embodiment;

FIG. 5 is a plot of radiation efficiency versus frequency of the first embodiment;

FIG. 6 is a plot of voltage standing wave ratio versus frequency of the first embodiment;

FIG. 7 is a schematic structure diagram of a second embodiment of the miniature antenna according to the present invention;

FIG. 8 is a plot of power gain versus frequency of the second embodiment;

FIG. 9 is a plot of average power gain versus frequency of the second embodiment; and

FIG. 10 is a plot of voltage standing wave ratio versus frequency of the second embodiment.

### DETAILED DESCRIPTION OF THE EMBODIMENTS

Before the present invention is described in greater detail with reference to the accompanying embodiments, it should be noted herein that like elements are denoted by the same reference numerals throughout the disclosure.

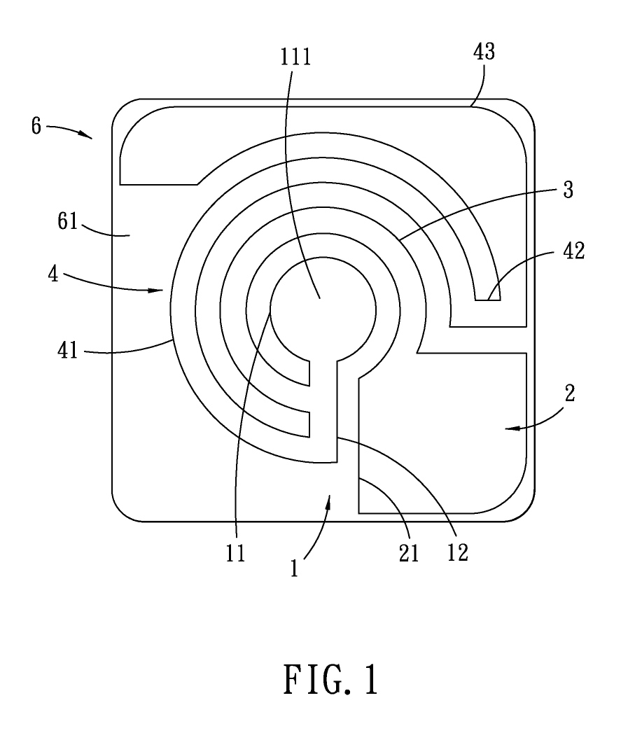

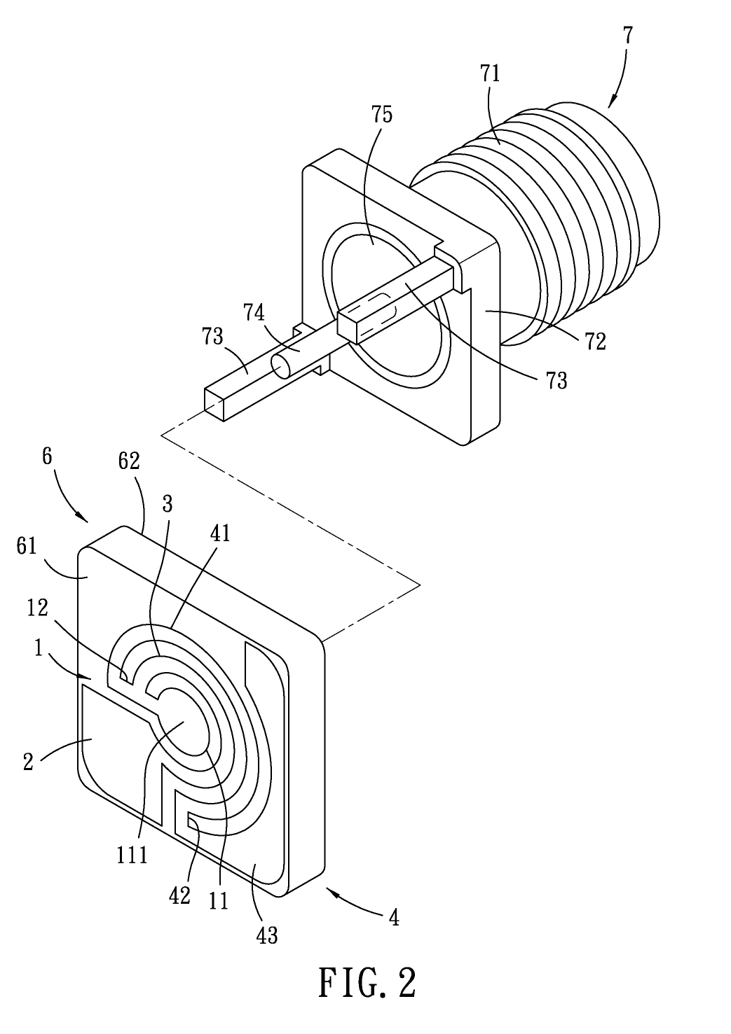

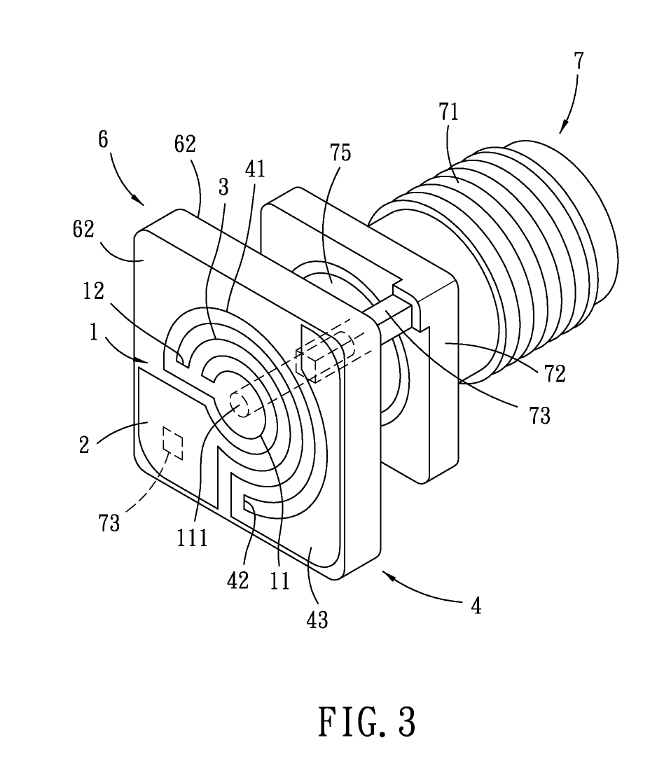

Referring to FIGS. 1 to 3, a first embodiment of a miniature antenna according to the present invention is shown to include a feed-in element 1, a grounding element 2, a short circuit element 3, a first radiating element 4, a substrate 6 and a subminiature connector 7.

The feed-in element 1 includes a feed-in end portion 11 and a link portion 12 connected electrically with the feed-in end portion 11. The feed-in end portion 11 has a circular contour and includes a feed-in point 111 provided for feed-in of a radio frequency signal. The link portion 12 extends outwardly from the feed-in end portion 11 (i.e., away from the feed-in end portion 11) and has an elongate shape. The grounding element 2 is substantially rectangular, and is spaced apart from the feed-in element 1. A vertex of the grounding element 2 is disposed adjacent to the feed-in point 111. The grounding element 2 has one edge 21 which is adjacent to the link portion 12 of the feed-in element 1 and which is spaced apart from and generally parallel to the link portion 12.

The short circuit element 3 is substantially arc-shaped, and extends from an edge of the link portion 12 opposite to the edge 21 and distal from the grounding element 2 in a clockwise direction to the vertex of the grounding element 2 that is disposed adjacent to the feed-in point 111. Moreover, the short circuit element 3 substantially surrounds and is spaced apart from the feed-in end portion 11. In this embodiment, the short circuit element 3 extends along a substantially 270-degree circular arc.

The first radiating element 4 includes a substantially arc-shaped first radiating section 41, a connecting section 42 and a second radiating section 43. The first radiating section 41 extends from the edge of the link portion 12 of the feed-in element 1 opposite to the edge 21 and distal from the grounding element 2 in a clockwise direction toward the grounding element 2, and substantially surrounds and is spaced apart from the short circuit element 3. In this embodiment, the first radiating section 41 extends along a substantially 270-degree circular arc. The connecting section 42 is connected to an end of the first radiating section 41 that is disposed adjacent the grounding element 2, and extends away from the feed-in end portion 11. The second radiating section 43 extends away from the grounding element 2 in a counterclockwise direction from an end of the connecting section 42 that is distal from the first radiating section 41, and is disposed outwardly of and spaced apart from the first radiating section 41. In this embodiment, the second radiating section 43 has an inner edge proximate to the first radiating section 41 and extending along a substantially 150-degree circular arc. The first radiating element 4 resonates in a first frequency band, and an overall length of the short circuit element 3 and the first radiating element 4 is substantially a quarter of a wavelength corresponding to the first frequency band. In this embodiment, the first frequency band substantially ranges from 2.4 GHz to 2.5 GHz, in compliance with the WiFi 802.11b.g.n protocols.

The substrate 6 has a first surface 61 and a second surface 62 opposite to the first surface 61. The feed-in element 1, the grounding element 2, the short circuit element 3 and the first radiating element 4 are disposed on the first surface 61. Precisely speaking, the substrate 6 is substantially rectangular, wherein the feeding end portion 11 of the feed-in element 1 is provided at the center of the first surface 61, and the ground conductor 2 is provided on one corner of the first surface 61. The subminiature connector 7 includes a conductive tube 71, a conductive frame 72 disposed at one end of the conductive tube 71, a plurality of conductive pillars 73 extending from the conductive frame 72 and away from the conductive tube 71, a conductive core 74 disposed inside the conductive tube in a non-contacting manner, and an insulator 75 disposed between the conductive tube 71 and the conductive core 74. One end of each of the conductive pillars 73 distal from the conductive frame 72 is disposed at the substrate 6, so that the subminiature connector 7 is connected to the substrate 6. Moreover, one of the conductive pillars 73 penetrates through the substrate 6 and is connected electrically with the grounding element 2, so that the grounding element 2 is conductively connected with the conductive frame 72 and the conductive tube 71 in order to receive grounding signals. The conductive core 74 extends toward the substrate 6, and one end of the conductive core 74 penetrates through the substrate 6 and is connected electrically with the feed-in point 111. In this way, the radio frequency signal is transmitted to the feed-in point 111 via the conductive core 74. In this embodiment, the substrate 6 is spaced apart from the conductive frame 72 by approximately 3 mm. The subminiature connector 7 is a SMA (SubMiniature version A) connector, and has a resistance of 50 ohms. However, the subminiature connector 7 is not limited to the SMA type only. Furthermore, in this embodiment, there are two of the conductive pillars 73, with one being used to connect electrically the grounding element 2, and the other being used to enhance the structural strength of the connection between the subminiature connector 7 and the substrate 6. It is worth mentioning herein that, in this embodiment, only two conductive pillars 73 are used instead of more so as to reduce the interference phenomenon between radiated signals.

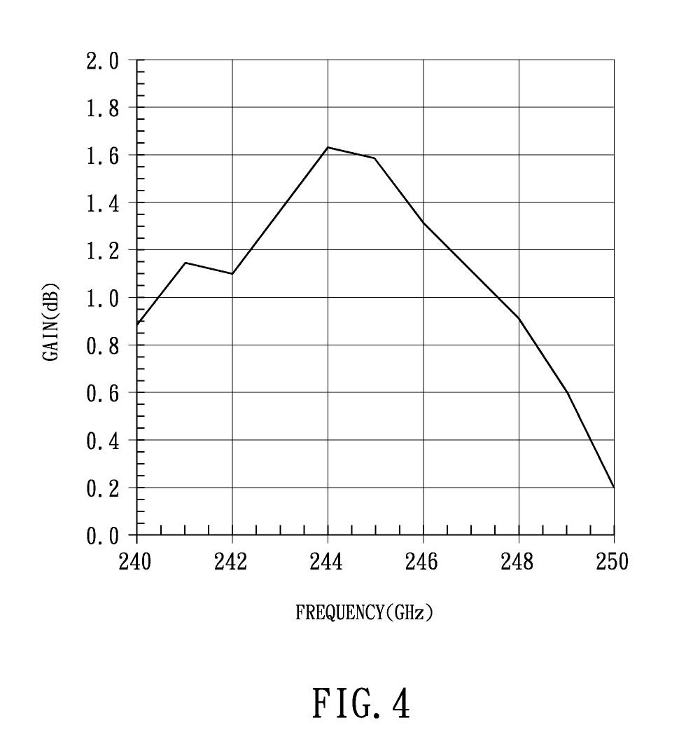

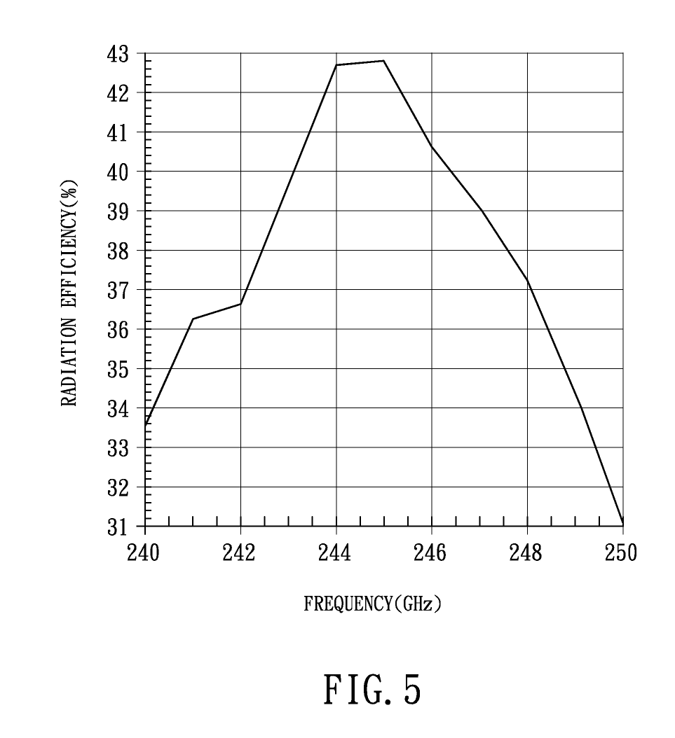

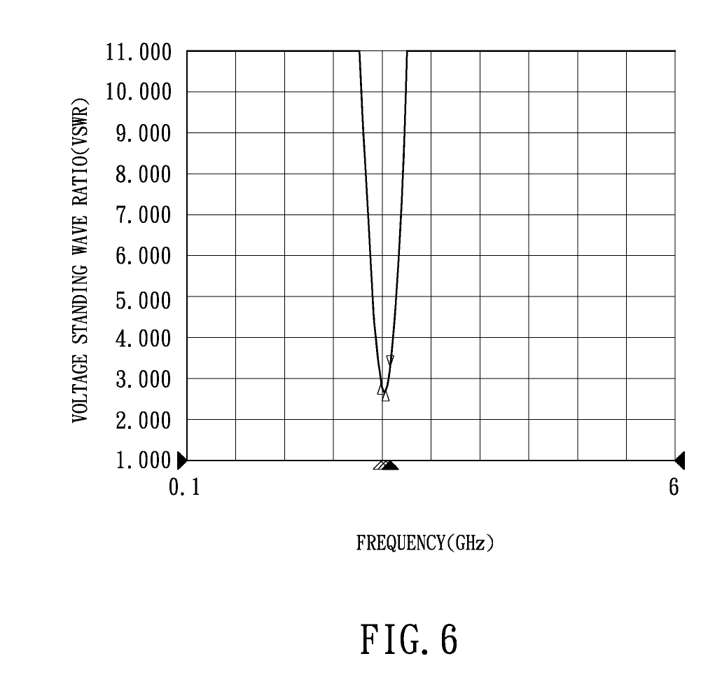

FIG. 4 and FIG. 5 are respectively plot of gain versus frequency and plot of radiation efficiency versus frequency of the first embodiment under a test frequency band. FIG. 4 and FIG. 5 show that the first embodiment has a good gain and radiation efficiency in the frequency band of 2.4 GHz-2.5 GHz. FIG. 6 and Table I below show the voltage standing wave ratio (VSWR) of the first embodiment. As shown in FIG. 6 and in Table I, the voltage standing wave ratio in the frequency band of 2.4 GHz-2.5 GHz is less than 3.3:1.

TABLE I

| Frequency (GHz) | VSWR |
|---|---|
| 2.4 | 2.8942 |
| 2.45 | 2.7272 |
| 2.5 | 3.2746 |

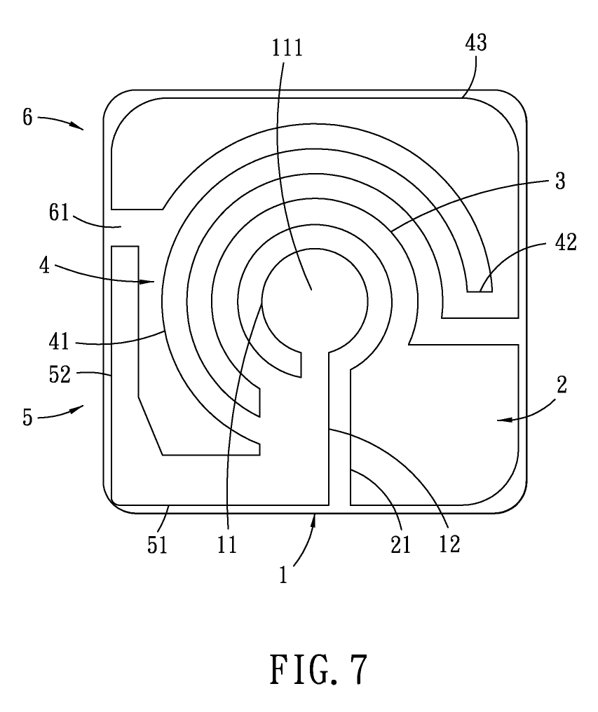

Referring to FIG. 7, a second embodiment of the miniature antenna according to the present invention is shown to be similar to the first embodiment and only differs in that, the second embodiment of the miniature antenna further comprises a second radiating element 5 which extends from the link portion 12. The second radiating element 5 includes a first radiating segment 51 that extends from the edge of the link portion 12 opposite to the edge 21 and distal from the grounding element 2 and that extends away from the feed-in element 1 and the grounding element 2, and a second radiating segment 52 that is connected electrically with an end of the first radiating segment 51 distal from the link portion 12 and that is generally perpendicular to the first radiating segment 51. The second radiating element 5 resonates in a second frequency band. In this embodiment, the second frequency band substantially ranges from 5.1 GHz to 5.8 GHz in compliance with the WiFi 802.11a protocol.

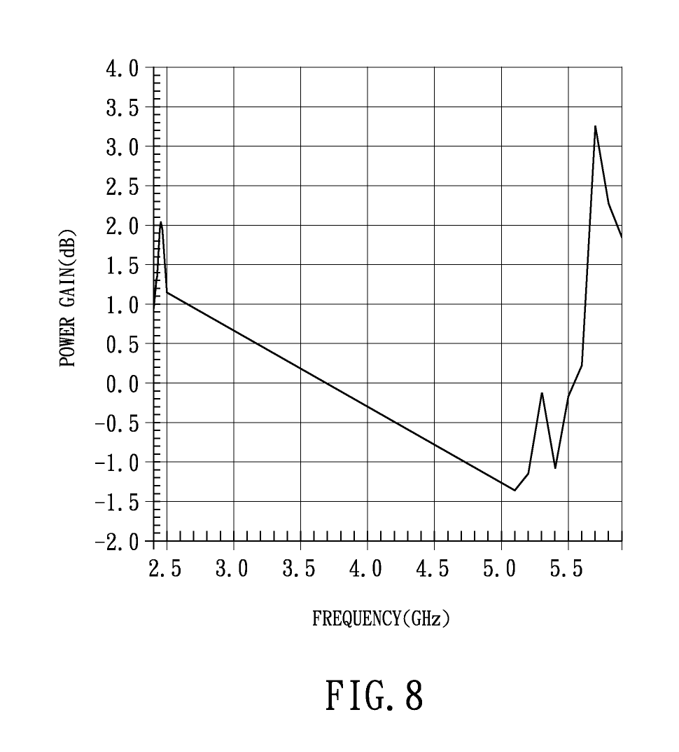

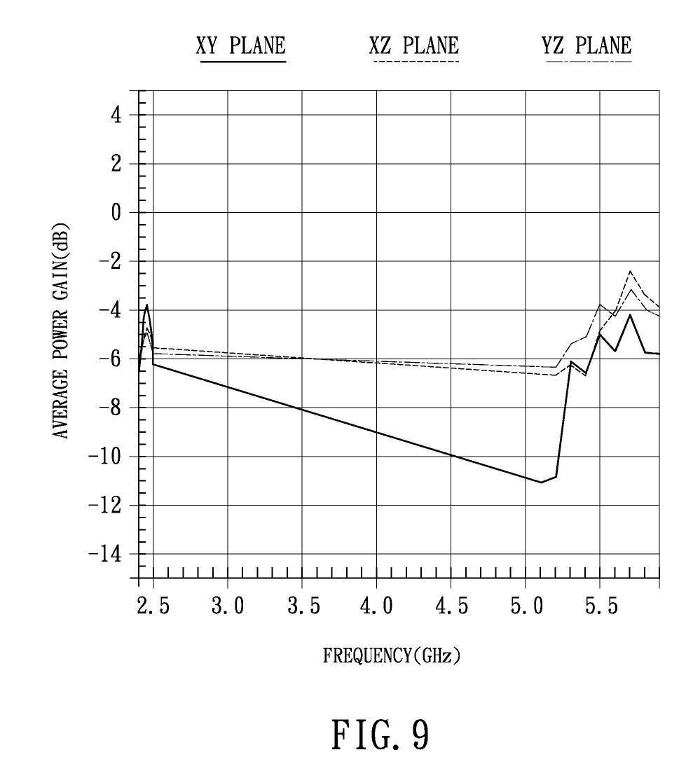

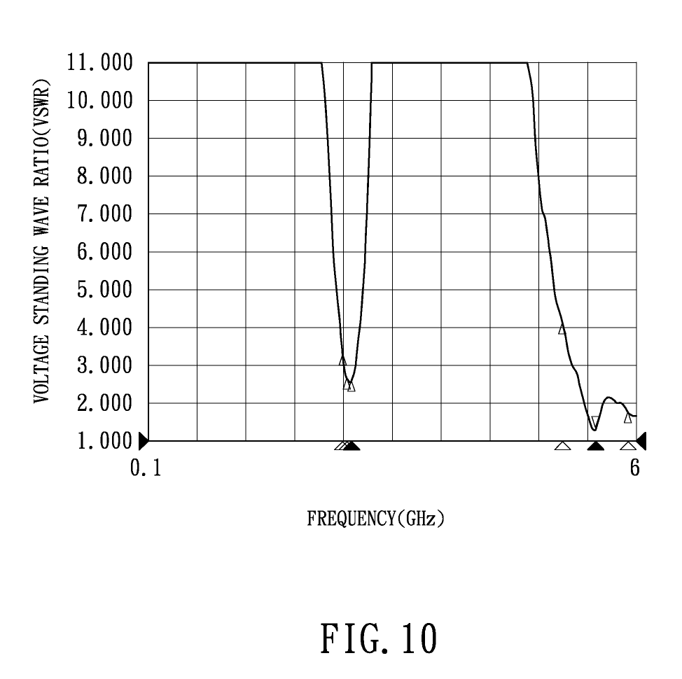

FIGS. 8 and 9 are respectively plot of power gain versus frequency and plot of average power gain versus frequency of the second embodiment under a test frequency band. FIG. 8 and FIG. 9 show that the second embodiment has a good gain and radiation efficiency in 2.4 GHz-2.5 GHz and in 5.1 GHz-5.8 GHz. FIG. 10 and Table II below show the voltage standing wave ratio (VSWR) of the second embodiment. As shown in FIG. 6 and in Table II, the voltage standing wave ratio in the frequency band of 5.1 GHz-5.8 GHz is less than 4.2:1, whereas the voltage standing wave ratio in the frequency band of 2.4 GHz-2.5 GHz is less than 3.3:1.

TABLE II

| Frequency (GHz) | VSWR |
|---|---|
| 2.4 | 3.3049 |
| 2.45 | 2.6800 |
| 2.5 | 2.5970 |
| 5.1 | 4.1234 |
| 5.5 | 1.3293 |
| 5.9 | 1.7763 |

It is worth mentioning that, in comparison with a conventional inverted F antenna operating in the WiFi frequency bands, the miniature antenna of this invention may have the size thereof reduced from 3 cm to 6 mm, i.e. a 80% size reduction.

To sum up, in this invention, by configuring the short circuit element 3 to extend from the link portion 12 to the grounding element 2 and to substantially surround the feed-in end portion 11, and by configuring the first radiating element 4 to extend from the link portion 12 and to substantially surround the short circuit element 3 and the feed-in end portion 11, the miniature antenna indeed achieves the miniaturization effect while maintaining good performance.

While the present invention has been described in connection with what are considered the most practical embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A miniature antenna comprising:
a feed-in element which includes a feed-in end portion and a link portion connected electrically with said feed-in end portion, said feed-in end portion including a feed-in point provided for feed-in of a radio frequency signal;
a grounding element spaced apart from said feed-in element and disposed adjacent to said feed-in point;
a short circuit element extending from said link portion to said grounding element, and substantially surrounding said feed-in end portion; and
a first radiating element extending from said link portion and substantially surrounding said short circuit element.

2. The miniature antenna as claimed in claim 1, wherein said first radiating element includes:
a first radiating section extending substantially as an arc from said link portion toward said grounding element to substantially surround said short circuit element;
a connecting section connected to said first radiating section, and extending away from said feed-in end portion; and
a second radiating section extending substantially as an arc from said connecting section and away from said grounding element to be disposed outwardly of said first radiating section;
wherein one of said first and second radiating sections extends in a clockwise direction, and the other one of said first and second radiating sections extends in a counterclockwise direction.

3. The miniature antenna as claimed in claim 2, wherein said first radiating section extends substantially as a 270-degree circular arc.

4. The miniature antenna as claimed in claim 2, wherein said second radiating section extends substantially as a 150-degree circular arc.

5. The miniature antenna as claimed in claim 1, wherein said short circuit element is substantially arc-shaped.

6. The miniature antenna as claimed in claim 5, wherein said short circuit element extends substantially as a 270-degree circular arc.

7. The miniature antenna as claimed in claim 1, wherein said grounding element has one edge which is adjacent to said link portion and which is spaced apart from and parallel to said link portion.

8. The miniature antenna as claimed in claim 1, further comprising a second radiating element which extends from said link portion, wherein said first radiating element and said second radiating element resonate in a first frequency band and a second frequency band, respectively.

9. The miniature antenna as claimed in claim 8, wherein an overall length of said short circuit element and said first radiating element is substantially a quarter of a wavelength corresponding to the first frequency band.

10. The miniature antenna as claimed in claim 9, wherein said second radiating element includes:
a first radiating segment extending from said link portion and away from said feed-in element and said grounding element, and
a second radiating segment connected electrically with said first radiating segment and being substantially perpendicular to said first radiating segment.

11. The miniature antenna as claimed in claim 8, further comprising:
a substrate which has a first surface and a second surface opposite to said first surface, said feed-in element, said grounding element, said short circuit element, said first radiating element and said second radiating element being disposed on said first surface; and
a subminiature connector which includes a conductive tube, a conductive frame disposed at one end of said conductive tube, a plurality of conductive pillars extending from said conductive frame and away from said conductive tube, a conductive core disposed inside said conductive tube in a non-contacting manner, and an insulator disposed between said conductive tube and said conductive core;
wherein one end of each of said conductive pillars distal from said conductive frame is disposed at said substrate, one of said conductive pillars penetrates through said substrate and is connected electrically with said grounding element, one end of said conductive core penetrates through said substrate and is connected electrically with said feed-in point, and said conductive core is used for transmission of the radio frequency signal to said feed-in point.

12. The miniature antenna as claimed in claim 11, wherein said substrate is spaced apart from said conductive frame by approximately 3 mm.

13. The miniature antenna as claimed in claim 8, wherein the first frequency band substantially ranges from 2.4 GHz to 2.5 GHz.

14. The miniature antenna as claimed in claim 8, wherein the second frequency band substantially ranges from 5.1 GHz to 5.8 GHz.
